(19) United States
(12) Patent Application Publication
(10) Pub. No.: US 2010/0149229 A1
(43) Pub. Date: Jun. 17, 2010

(54) CONTROLLING DIGITAL PRINTING

(75) Inventors: Michael James Diehl, Rochester, NY (US); Andrew James Bonacci, Webster, NY (US); Colleen R. Enzien, Penfield, NY (US); Thomas Edward Higgins, Fairport, NY (US); David Robert Kretschmann, Webster, NY (US); Carlos A. Lopez, Webster, NY (US); Ana Perez Tooker, Penfield, NY (US); Jacqueline Yvonne Tyson, Rochester, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/335,858

(22) Filed: Dec. 16, 2008

(51) Int. Cl. B41J 29/38

(52) U.S. Cl. 347/5

(57) ABSTRACT

A method and system for digital printing with plural marking engines in which a controller determines which of the marking engines has first completed its initialization/warm-up cycle and begins printing on that marking engine. As additional marking engines complete their initialization/warm-up cycle, additional concurrent printing is commenced on them.

### BACKGROUND

The present disclosure relates to digital printing and particularly to printing arrangements utilizing plural marking engines for increasing productivity where a large number of printed copies are to be made from a single document or set of images. In digital printing on cut sheet print media, it is often desirable to have more than one marking engine available in tandem in the sheet media path for executing a print job, particularly where a large number of copies are to be made or where the document contains a large number of pages and multiple copies are needed. The use of tandem plural marking engines decreases the time required to complete a duplex print job inasmuch as the sheets may be printed or marked on both sides simultaneously in the plural marking engines.

However, where the digital printing system has plural tandem marking engines available, upon initialization or start-up, the system heretofore was required to wait until all marking engines were sufficiently initialized or reached completion of their individual warm-up cycle before printing or marking could begin. Thus, in the event that one of the marking engines was slow to initialize or complete its warm-up cycle, the entire print job was delayed by that amount of time. The problem of delaying startup of printing or marking in digital printing systems employing tandem marking engines is particularly noticeable to the user where any of the tandem marking engines have multiple marking capabilities such as color and exhibit longer initialization/warm-up times than systems employing a single marking capability as, for example, systems limited to monochromatic marking or printing.

Thus, it has been desired to provide a way or means of decreasing the time required to begin a print job upon startup where plural tandem marking engines are employed for increased productivity.

### BRIEF DESCRIPTION

The present disclosure describes a method of controlling or operating a digital printing system employing tandem marking engines in which the controller for the marking engines is capable of determining which of the marking engines is first to complete its initialization/warm-up cycle. In the event that there is a marking engine upstream in the media path which has not completed its initialization/warm-up cycle, the controller is operable to effect bypassing the upstream marking engine in favor of immediate printing on the downstream engine which has completed its initialization/warm-up cycle. The method of the present disclosure thus enables a user to begin printing sooner on the printing system thereby increasing the overall productivity of the system. As the additional marking engines in the media path complete their initialization/warm-up cycle they are then brought online in the printing process and the full capability of the printing system is appreciated.

### BRIEF DESCRIPTION OF THE DRAWINGS

FIG. 1 is a schematic of a digital printing system employing plural marking engines in tandem for a single cut sheet media path; and,

FIG. 2 is block flow diagram of the method of the present disclosure.

### DETAILED DESCRIPTION

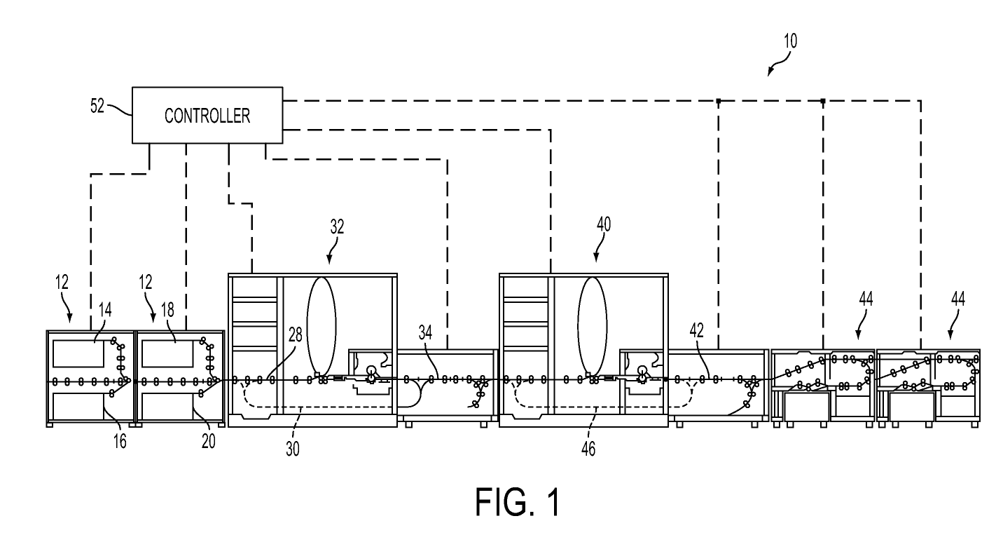

Referring to FIG. 1, a digital printing system is indicated generally at 10 and includes a feeder module indicated generally at 12 which outputs sheet stock from trays 14, 16 or stackers 18, 20 along a path to the first marking engine indicated generally at 32. Marking engine 32 is capable of selectively directing cut sheet media along input path 28 for marking or along a by-pass path 30.

A second marking engine indicated generally at 40 receives marked media from the discharge path 34 of marking engine 32 and outputs the media along an output path 42 to a stacker/finisher module series indicated generally at 44. The second marking engine 40 also includes a bypass transport path 46 which can receive cut sheet media directly from the discharge path 34 of the marking engine module 32 for direct by-pass to the output module 42.

Additionally, the architecture is such that either marking engine may print two sided output, i.e. duplex, while the other engine is in the process of warming/cycling up, by recirculating sheets along the paths 30 or 46 for the engines 32, 40 respectively.

Thus, the system of FIG. 1 is capable of directing cut sheet media to either of the marking engines 32 or 40 depending on which is first to complete its initialization/warm-up cycle. Each of the modules 12, 32, 40, 44 is electrically connected to a controller 52 for effecting the desired operations of the modules; and, the controller is connected to a user input interface (not shown) in a manner well known in the art.

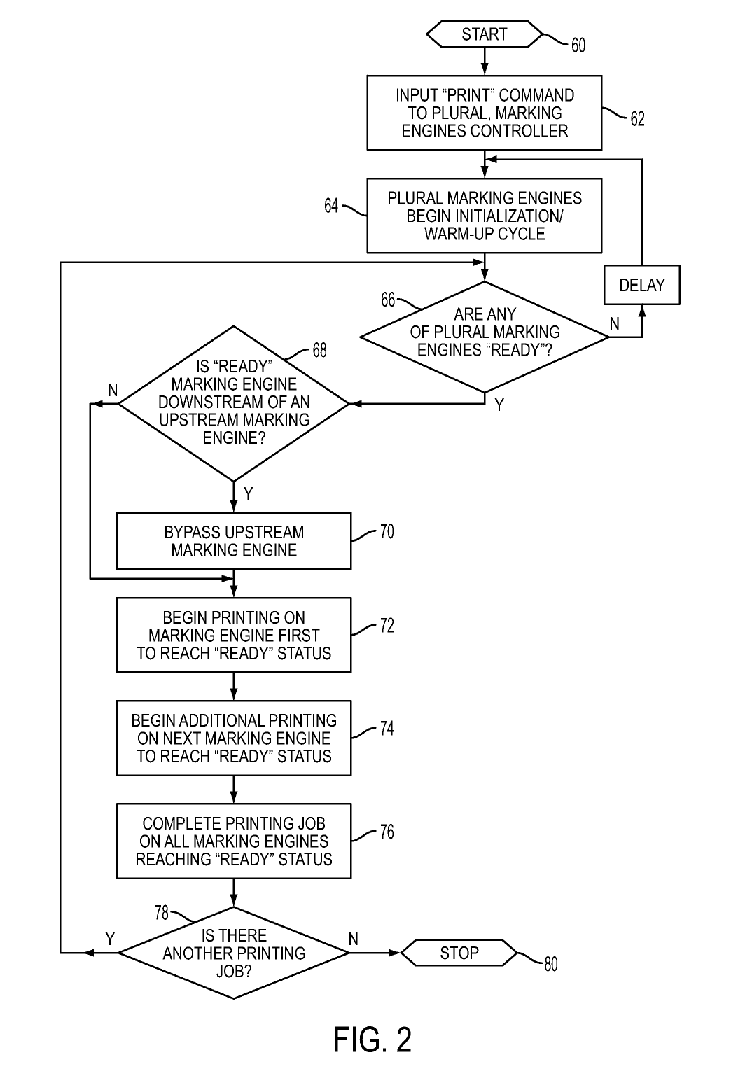

Referring to FIG. 2, the method of the present disclosure is indicated wherein the system begins at step 60 with a user input to “start” and proceeds to step 62 to respond to a user “print” input to the controller for the plural marking engines.

The system then proceeds to step 64 where the controller begins the initialization/warm-up cycle for all of the marking engines. The system then proceeds to step 66 and inquires as to whether any of the plural marking engines are “ready” i.e., have completed their initialization/warm-up cycle. If the answer to the query at step 66 is negative, the system returns to step 64 after a predetermined delay, which may be on the order of a few seconds or fractions of a minute, in order to permit the continuation of the initialization/warm-up cycles. In the present practice, the delay period may be chosen so as to allow at least one marking engine to complete an initiation/warm-up cycle. It will be understood, however, that if the delay is chosen of sufficient length, all marking engines may have completed their respective initialization/warm-up cycle before printing begins.

If however, the query at step 66 is answered in the affirmative, the system proceeds to step 68 and enquires as to whether the marking engine which has achieved “ready” status is downstream of an upstream marking engine. If the query at step 68 is answered in the affirmative, the system proceeds to step 70 and bypasses the upstream marking engine and proceeds to step 72. If the query at step 68 is answered in the negative, the system bypasses the downstream marking engine and then proceeds directly to step 72.

At step 72, the system controller initiates printing on the first marking engine to reach the stations “ready” status. The system then proceeds to step 74 and begins additional printing on the next marking engine to reach “ready” status. The system then proceeds to step 76 and institutes printing on all marking engines reaching the “ready” status. The system then proceeds to step 78 and enquires as to whether there is another printing job; and, if the answer is in the negative, the system proceeds to step 80 to stop. However, if the query at step 78 is answered in the affirmative, the system returns to step 66.

The present disclosure thus describes a method of operating a digital printing system having plural marking engines connected in tandem whereupon initiation of the initialization/warm-up cycle of the marking engines the controller for the system is operative to begin printing immediately on the first of the marking engines to complete an initialization/warm-up cycle. The controller is operative to thereafter bring on-line each additional marking engine as it completes its initialization/warm-up cycle to thereby increase the operating efficiency of a tandem marking engine printing system.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. a method of controlling digital printing comprising:
(a) providing a plurality of digital marking engines;
(b) disposing a controller operatively connected to each of the marking engines;
(c) initiating concurrently an initialization/warm-up cycle on each of the marking engines;
(d) determining the completion of the initialization/warm-up cycle of each marking engine; and,
(e) initiating a print job on the marking engine first to complete the initialization/warm-up cycle.

2. The method defined in claim 1, further comprising initiating concurrent printing on the marking engine next completing the initialization/warm-up cycle.

3. The method defined in claim 1, further comprising initiating concurrent printing on each marking engine as it completes the initialization/warm-up cycle.

4. The method defined in claim 1, wherein the step of providing a plurality of marking engines includes providing a plurality of marking engines disposed in tandem for single path media feed; and, by passing at least one upstream marking engine in the event a downstream marking engine is first to complete the initialization/warm-up cycle.

5. A digital printing system comprising:
(a) a plurality of digital marking engines each having a print engine controller operative for upon initiation performing a initialization/warm-up cycle; and a digital front end (DFE) for job submittal.
(b) a print engine controller connected to each of the marking engines and operative to schedule print media thereto for marking, wherein the controller schedules print media initially to the first of said marking engines at the end of the initialization/warm-up cycle.

6. The system defined in claim 5, wherein the marking engines are connected in tandem for single path media flow and the controller is operative to by-pass an upstream marking engine in the event a downstream marking engine is first to complete the initialization/warm-up cycle.
